(19) United States
(12) Patent Application Publication
(10) Pub. No.: US 2007/0217583 A1
(43) Pub. Date: Sep. 20, 2007

(54) Communication device outside-connected incoming call indicator and earphone device having such an incoming call indicator

(75) Inventors: Kuo-Chih Lee, Taipei (TW); Chiao-Yu Yu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/378,473

(22) Filed: Mar. 20, 2006

(51) Int. Cl. H04M 15/06; H04M 1/56

(52) U.S. Cl. 379/142.01

(57) ABSTRACT

A communication device outside-connected incoming call indicator and an earphone device having such an incoming call indicator are provided. The incoming call indicator has a first communication port connected to a communication device, which is used to receive the incoming call; and an incoming call indication module used to detect the incoming signal and send out an incoming call indication. The earphone device with the incoming call indicator has a connector, which is used to connect to a communication device provided with an insertion hole, and receive the incoming call signal transmitted from the communication device; an incoming call indicator, which is used to receive the incoming call signal and send out an incoming call indication; and an earphone, which is used to receive and broadcast the voice signals transmitted from the communication device. A signal wire is used to connect the connector, the incoming call indicator, and the earphone.

### BACKGROUND OF THE INVENTION

1. Field of the Invention

The invention relates to an incoming call indicator, and in particular to a communication device outside-connected incoming call indicator and an earphone device having such an incoming call indicator.

2. Related Art

With the rapid progress and development of wireless communication technology, the functions and quality of mobile phone communications have improved tremendously. The size of the mobile phone has been reduced and is thus easier to carry, and its price has been reduced steadily, so that it is widely popularized and is available to most people. As such, many manufacturers have been attracted into this lucrative market and dedicated to developing and producing mobile phones and their various peripheral devices, such as the hands-free-headset. In many instances, such as when driving a vehicle or riding a motor cycle, it is very inconvenient or sometimes impossible for the user to hold the mobile phone in his or her hand while making the phone conversation. Therefore, presently, when purchasing a new mobile phone, a free hands-free-headset is provided for the convenience of the user.

Refer to FIG. 1, which shows a schematic diagram of the structure of a hands-free-headset of a mobile phone according to the prior art. As shown in FIG. 1, the hands-free-headset 150 is provided with a connector 156 used to plug in a mobile phone 110 through a plug-in hole 112. In addition, the hands-free-headset 150 is further provided with an earphone 152 and a microphone 154, and a signal wire 158 is used to connect the earphone 152, the microphone 154, and the connector 156 into an integral body.

Upon receiving incoming calls, the user may press a communication button 114 on the mobile phone 110, and at the same time put a pair of earphones 152 in his or her ears so that he/she can hear the incoming call from the mobile phone 110 through the earphones 152. Then, the user can send his or her voice to the mobile phone 110 through the microphone 154 to communicate with the person at the remote end. In this way, the user does not have to hold the mobile phone 110 in his or her hand during communication by making use of the hands-free-headset 150, so as to facilitate communication.

However, presently, most people are not in the habit of putting the mobile phone in their pocket or hanging it in front of their chest. Instead, they prefer to put it in a pocket or bag, with the outside-connected hands-free-headset hanging around them. As such, when the user is outdoors or in a noisy location, the rings of the mobile phone may not be heard, and the incoming call will be missed. However, if the hands-free-handset hanging around the user is also capable of sending out the ring to alert the user, then the chance of missing the incoming calls can be significantly reduced.

### SUMMARY OF THE INVENTION

The object of the invention is to provide a communication device outside-connected incoming call indicator and an earphone device having the incoming call indicator. The incoming call indicator is connected to the communication device through a signal wire. Upon receiving an incoming call, the incoming call indicator sends out an incoming call indication signal to alert the user. Thus, even if the mobile phone is not hanging in front of the user's chest, he/she can still be informed of the incoming call. In this manner, the problem of missing calls of the prior art is solved.

Therefore, to achieve the above-mentioned object, the invention provides an outside-connected incoming call indicator of a communication device, including:

A first communication port, which is connected to a communication device through a signal wire or transmission wire, and is used to receive the incoming call transmitted from the communication device; and

An incoming call indication module, which is used to detect the incoming call transmitted via the communication device and send out an incoming call indication signal, such as a musical ring, to inform the user of the incoming call.

In addition, the invention provides an earphone device having an incoming call indicator for the communication device, including:

A connector, which is plugged into the a plug-in hole of the communication device and used to receive the incoming call signals transmitted through the communication device;

An incoming call indicator, which is connected to the connector through a signal wire, thus receiving the incoming call signals and sending out an incoming call indication signal; and

An earphone, which is connected to the incoming call indicator and used to receive and broadcast the contents of the incoming call, so that the user may hear the contents of the incoming call.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention.

FIG. 1 is a schematic diagram of the structure of a hands-free-headset of a mobile phone according to the prior art;

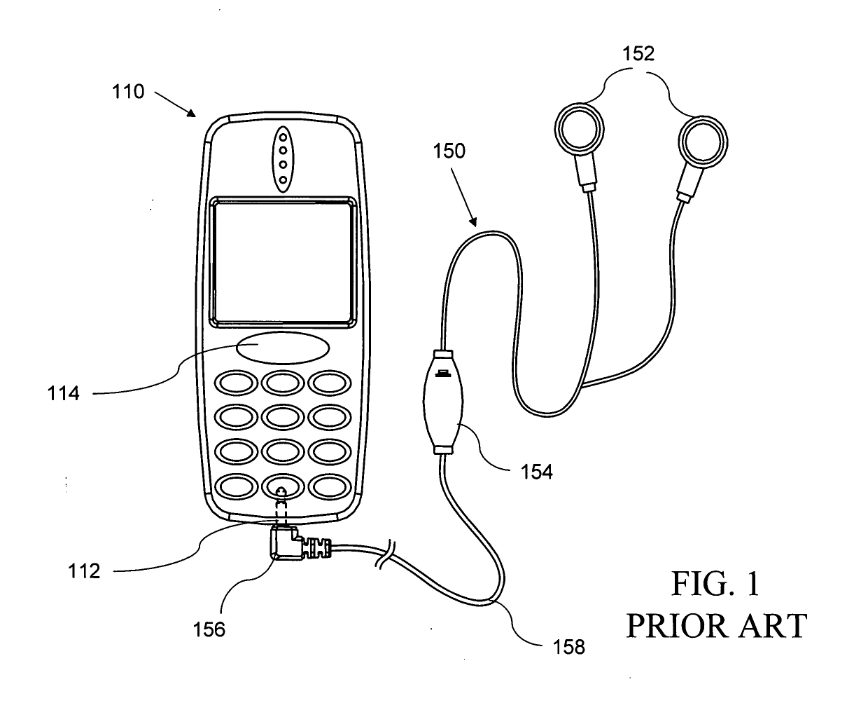

FIG. 2 is a system block diagram of the structure of a communication device outside-connected incoming call indicator according to an embodiment of the invention;

FIG. 3 is a schematic diagram of a communication device outside-connected earphone device having an incoming call indicator according to an embodiment of the invention; and

FIG. 4 is a system block diagram of the structure of a communication device outside-connected earphone device having an incoming call indicator according to another embodiment of the invention.

### DETAILED DESCRIPTION OF THE INVENTION

The purpose, construction, features, and functions of the invention can be appreciated and understood more thoroughly through the following detailed description with reference to the attached drawings.

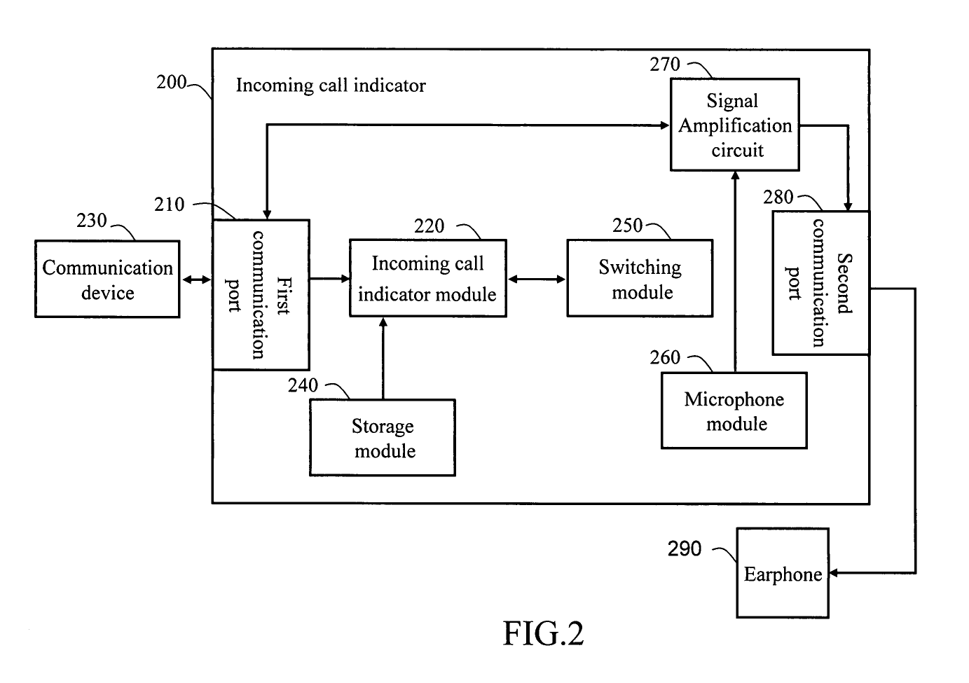

Refer to FIG. 2, which shows a system block diagram of the structure of a communication device outside-connected incoming call indicator according to an embodiment of the invention. The incoming call indicator 200 includes at least a first communication port 210 and an incoming call indicator module 220. The detailed descriptions of the respective devices are given as follows.

The first communication port 210 is used to connect to a communication device 230, such as a mobile phone, and receive the incoming call signal transmitted from the communication device 230. The first communication port 210 can be an insertion hole, such that it can be connected to another insertion hole located in the communication device 230 through a signal wire having a connector at both ends. Namely, an outside signal wire is used to connect the communication device 230 and the first communication port 210 of the incoming call indicator 200.

The incoming call indicator module 220 is used to receive and detect the incoming call signals transmitted through the communication device 230, and send out an incoming call indication signal, which causes a ring indication or a vibration indication for the user.

In addition, the incoming call indicator 200 may further include a storage module 240, a switching module 250, a signal amplification module 270, a second communication port 280, and a microphone module 260. The details of the respective devices are given as follows.

The storage module 240 is used to connect to the incoming call indication module 220 and store the incoming call indication to be taken. Thus, when an incoming call signal is detected by the incoming call indication module 220, then an incoming call indication is retrieved from the storage module 240 and is then executed—it may be a ring indication or a vibration indication.

The switching module 250 is used to enable the user to decide for him or her self if he/she desires to be connected to and to hear from the communication device 230. If the decision is affirmative, then the incoming call indication module 220 stops executing the incoming call indication. The switching module 250 may be a press button, such that the user is connected to the incoming call by pressing the button.

The signal amplification circuit 270 is used to amplify the voice signals received from the communication device 230 and then transmit them to the earphone 290 for the user to listen.

The second communication port 280 is used to connect to an earphone 290 and transmit the signals received from the communication device 230 after they are amplified by the signal amplification circuit 270. The second communication port 280 may be an insertion hole, which can be connected to a receptacle or an insertion hole provided on the earphone 290 through a signal wire, so that the second communication port 280 is connected to the earphone 290 to transmit signals. As such, the user has only to put the earphones 290 in his or her ears and be able to hear the incoming calls transmitted and amplified by the signal amplification circuit 270.

The microphone module 260 is used to transmit the voice signals of the user to the communication device 230 after they are amplified by the signal amplification circuit 270. Then the voice signals of the user are transmitted to the receiving end by the communication device 230 in a wireless manner.

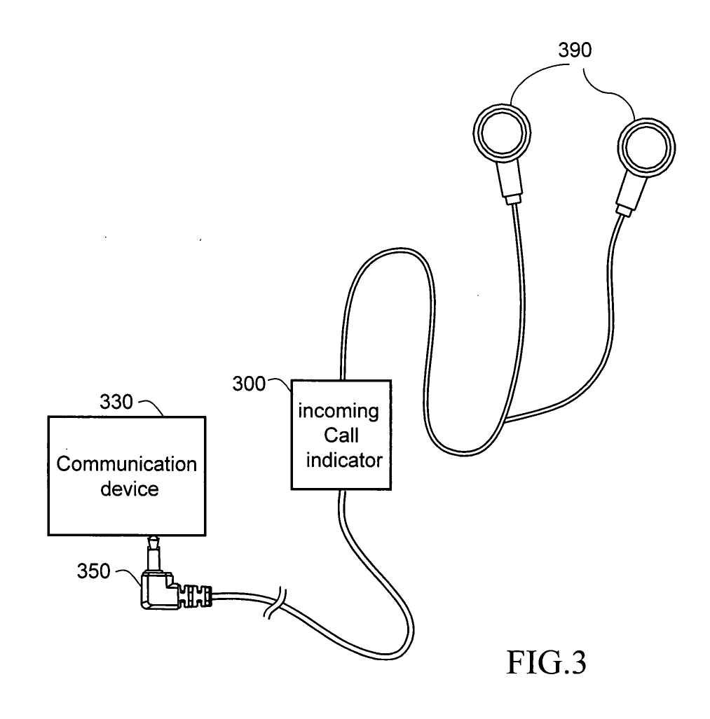

Subsequently, refer to FIG. 3, which shows a schematic diagram of a communication device outside-connected earphone device having an incoming call indicator according to an embodiment of the invention, including a connector 350, an incoming call indicator 300, and an earphone 390. A signal wire is used to connect the connector 350, the incoming call indicator 300, and the earphone 390 together as an integral body to transmit/receive signals to/from the communication device. The details of these devices will be described as follows.

The connector 350 is connected to an insertion hole of the communication device 330 and is used to receive the incoming call from the communication device 330. The communication device 330 may be a mobile phone device.

The incoming call indicator 300 is connected integrally to the connector 350 through a signal wire, and is used to receive the incoming call signals from the communication device 330, and produce and execute an incoming call indication, which may be a ring indication or a vibration indication.

The earphone 390 is connected integrally to the incoming call indicator 300 through a signal wire, and is used to transmit/receive the signals to/from the communication device 330.

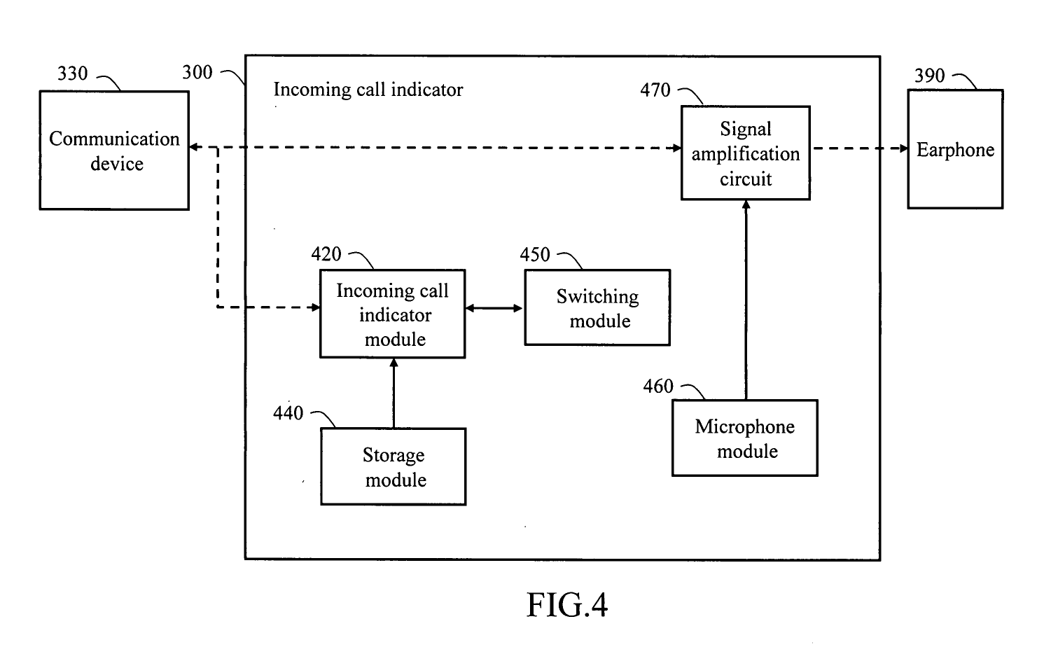

Finally, refer to FIG. 4, which shows a system block diagram of the structure of a communication device outside-connected earphone device having an incoming call indicator according to another embodiment of the invention. The incoming call indicator 300 further includes an incoming call indication module 420, a storage module 440, a switching module 450; a signal amplification circuit 470, and a microphone module 460.

The incoming call indication module 420 is used to detect the incoming call signal transmitted from the communication device 330, and produce and execute an incoming call indication to inform the user of the incoming call.

The storage module 440 is used to connect to the incoming call indication module 420, and store the incoming call indication to be taken. Thus, when an incoming call is detected by the incoming call indication module 420, an incoming call indication is retrieved from the storage module 440 and is then executed—it may be a ring indication or a vibration indication.

The switching module 450 is used to enable the user to decide for him or her self if he/she desires to be connected to and to hear from the communication device 330. If the decision is affirmative, then the incoming call indication module 420 stops executing the incoming call indication. The switching module 450 may be a push button.

The signal amplification circuit 470 is used to amplify the voice signals received from the communication device 330 and transmit them to the earphone 390 through a signal wire for the user to listen.

The microphone module 460 is used to transmit the voice signals of the user to the communication device 330 through a signal wire after they are amplified by the signal amplification circuit 470.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A communication device outside-connected incoming call indicator, comprising:
a first communication port, connected to a communication device, and is used to receive an incoming call transmitted from the communication device; and
an incoming call indication module, used to detect the incoming call signal, and send out an incoming call indication signal.

2. The communication device outside-connected incoming call indicator as claimed in claim 1, wherein the communication device is a mobile phone.

3. The communication device outside-connected incoming call indicator as claimed in claim 1, further comprising a storage module, which is used to store the incoming call indication, and connect to the incoming call indication module.

4. The communication device outside-connected incoming call indicator as claimed in claim 1, wherein the incoming call indication is a ring indication.

5. The communication device outside-connected incoming call indicator as claimed in claim 1, wherein the incoming call indication is a vibration indication.

6. The communication device outside-connected incoming call indicator as claimed in claim 1, wherein the first communication port is composed of an insertion hole, which is connected to a communication device having an insertion hole through a signal wire having a respective connector at both ends.

7. The communication device outside-connected incoming call indicator as claimed in claim 1, further comprising a switching module, which is used to enable the user to decide for himself if he desires to be connected to and to hear from the communication device, if the decision is affirmative, then the incoming call indication module is ceased from executing the incoming call indication.

8. The communication device outside-connected incoming call indicator as claimed in claim 7, wherein the switching module is a push button.

9. The communication device outside-connected incoming call indicator as claimed in claim 1, further comprising a second communication port, which is used to be connected to an earphone, and transmit to it the signals received from the communication device after they being amplified by a signal amplification circuit.

10. The communication device outside-connected incoming call indicator as claimed in claim 9, wherein the second communication port is an insertion hole.

11. The communication device outside-connected incoming call indicator as claimed in claim 9, wherein the earphone is provided with a receptacle, so that it may be connected to the second communication port through a signal wire.

12. The communication device outside-connected incoming call indicator as claimed in claim 1, further comprising a microphone module, which is used to transmit the voice signals of the user to the communication device through a signal wire after they being amplified by the signal amplification circuit.

13. A communication device outside-connected earphone device having an incoming call indicator, comprising:
a connector, used to connect to a communication device provided with an insertion hole, and receive the incoming call transmitted from the communication device;
an incoming call indicator, connected to the connector, and is used to receive the incoming call signal and send out an incoming call indication; and
an earphone, connected to the incoming call indicator, and is used to receive and broadcast the voice signals transmitted from the communication device;
wherein a signal wire is used to connect the connector, the incoming call indicator, and the earphone together as an integral body to transmit the incoming call to/from the earphone.

14. The communication device outside-connected earphone device having an incoming call indicator as claimed in claim 13, wherein the communication device is a mobile phone.

15. The communication device outside-connected earphone device having an incoming call indicator as claimed in claim 13, wherein the incoming call indicator further comprising an incoming call indication module, which is used to detect the incoming call signals, and send out the incoming call indication.

16. The communication device outside-connected earphone device having an incoming call indicator as claimed in claim 13, wherein the incoming call indicator further comprising a storage module, which is used to store the incoming call indication, and connect to the incoming call indication module.

17. The communication device outside-connected earphone device having an incoming call indicator as claimed in claim 13, wherein the incoming call indication is a ring indication.

18. The communication device outside-connected earphone device having an incoming call indicator as claimed in claim 13, wherein the incoming call indication is a vibration indication.

19. The communication device outside-connected earphone device having an incoming call indicator as claimed in claim 13, wherein the incoming call indicator further comprising a switching module, which is used to enable the user to decide for himself if he desires to be connected to and to hear from the communication device, if the decision is affirmative, and then the incoming call indication module is ceased from executing the incoming call indication.

20. The communication device outside-connected earphone device having an incoming call indicator as claimed in claim 19, wherein the switching module is a push button.

21. The communication device outside-connected earphone device having an incoming call indicator as claimed in claim 13, wherein the incoming call indicator further comprising a signal amplification circuit, which is used to amplify the voice signals received from the communication device and transmit them to the earphone through a signal wire for the listening of the user.

22. The communication device outside-connected earphone device having an incoming call indicator as claimed in claim 13, wherein the incoming call indicator farther comprising a microphone module, which is used to transmit the voice signals of the user to the communication device through a signal wire after they being amplified by the signal amplification circuit.
